(19) United States
(12) Patent Application Publication
(10) Pub. No.: US 2011/0045851 A1
(43) Pub. Date: Feb. 24, 2011

(54) AD-HOC GROUP FORMATION FOR USERS OF MOBILE COMPUTING DEVICES

(75) Inventors: W. Keith Maddox, Short Hills, NJ (US); Deborah J. Jackson, Johns Creek, GA (US)

Correspondence Address: BROWN RUDNICK LLP, ONE FINANCIAL CENTER, BOSTON, MA, 02111, US

(73) Assignee: Gabber Communications, Inc., Short Hills, NJ (US)

(21) Appl. No.: 12/860,516

(22) Filed: Aug. 20, 2010

Related U.S. Application Data
(60) Provisional application No. 61/235,780, filed on Aug. 21, 2009.
(60) Provisional application No. 61/235,795, filed on Aug. 21, 2009.

(51) Int. Cl. H04W 4/00

(52) U.S. Cl. 455/466

(57) ABSTRACT

Systems and methods for ad-hoc group formation for users of mobile computing devices are described. The systems and methods include a communication server and mobile computing devices. Each of the communication server and the mobile computing devices includes a processor and a storage medium embedded with instructions that are executable by the processor. The communication server facilitates the communication of text messages received from the mobile computing device to a group of mobile computing devices without intervention by an owner of the group of mobile computing devices.

### CROSS-REFERENCE TO RELATED APPLICATIONS

This claims priority to and the benefit of U.S. Provisional Application No. 61/235,795, filed on Aug. 21, 2009, and U.S. Provisional Patent Application No. 61/235,780, filed on Aug. 21, 2009, the entire contents of which are incorporated herein by reference.

### TECHNICAL FIELD

The invention relates to systems and methods for ad-hoc group formation, and more particularly, to ad-hoc group formation for users of mobile computing devices via various wireless messaging paradigms.

### BACKGROUND INFORMATION

The use of mobile computing devices for sending text messages to a group of multiple recipients can be cumbersome for the users of the devices.

Some commercially available systems and methods are limited by the manner in which they can distribute text messages to a group of recipients. For example, such systems and methods require a user of a mobile computing device to provide a phone number for each recipient or individually select names stored in an address book. In such cases, the act of entering multiple addresses is difficult even if the addresses are present in the address book on the user's mobile device. In addition, in instances in which users of such mobile devices wish to enter a group and other members wish to exit the group, the act of managing such an informal, yet dynamic group becomes extremely difficult, if not impossible. Accordingly, these systems and methods do not provide the functionality and versatility necessary to facilitate ad-hoc and dynamic group formation among users of mobile devices.

### SUMMARY OF THE INVENTION

The invention relates to systems and methods for ad-hoc group formation for users of mobile computing devices. Systems and methods according to the invention are less cumbersome and more versatile relative to existing systems and methods for facilitating ad-hoc and dynamic group formation among users of mobile devices. This is accomplished, for example, by systems and methods according to the invention allowing ad-hoc and dynamic group formation among users of mobile devices without the intervention by an owner of the group.

In one aspect, the invention relates to a communication server that includes a processor and a storage medium embedded with instructions. The instructions are executable by the processor for: causing the processor to communicate a text message between a mobile computing device and a group of mobile computing devices; causing the processing to analyze the text message transmitted from the mobile computing device; and causing the processor to broadcast the message to the group of mobile computing devices based upon a group name identifier without intervention by the owner of the group. The group of mobile computing devices has an owner for managing the group. The group name identifier identifies the group of mobile computing devices.

In one embodiment according to this aspect of the invention, the communication server can include an electronic service that is configured for attributing a credit to the owner of the group for each mobile computing device that joins the group of mobile computing devices in response to an invitation by the owner of the group. The electronic service can create a parent-child relationship between the owner of the group and the mobile computing device that joined the group of mobile computing devices in response to the invitation by the owner of the group. The owner of the group can also receive a credit for each mobile computing devices that joins the group in response to an invitation by the child.

In another embodiment according to this aspect of the invention, the mobile computing device can include any one or more of a mobile phone, a mobile computer, a personal digital assistant, and a smart phone. The storage medium can include any one or more of random access memory (RAM), read-only memory (ROM), and flash memory.

In another embodiment according to this aspect of the invention, the text message can include any one or more of a short message service (SMS) message, a multi-media messaging service (MMS) message, an instant message (IM), a facsimile, and an electronic mail (e-mail). The text message can also include any one or more of a plurality of commands to communicate with the communication server.

The text message can include a user name identifier that is associated with each of the mobile computing devices of the group of mobile computing devices. The user name identifier can include a phone number. The phone number may not be visible to the group of mobile computing devices.

In another embodiment according to this aspect of the invention, the communication server can be wirelessly connected to the mobile computing device and the group of mobile computing devices.

In a second aspect, the invention relates to a method of facilitating ad-hoc group formation via a communication server. The methods includes receiving a text message from a mobile computing device, such as the mobile computing device described above, analyzing the text message and the group name identifier, and broadcasting the text message to the group of mobile computing devices based upon the group name identifier without intervention by the owner of the group.

In one embodiment according to this aspect of the invention, the method can include attributing a credit to the owner of the group for each mobile computing device that joins the group of mobile computing devices in response to an invitation by the owner of the group. The method can also include creating a parent-child relationship between the owner of the group and the mobile computing device that joined the group of mobile computing devices in response to the invitation by the owner of the group. The method can also include attributing a credit to the owner of the group for each mobile computing devices that joins the group in response to an invitation by the child.

In another embodiment according to this aspect of the invention, the mobile computing device can include any one or more of a mobile phone, a mobile computer, a personal digital assistant, and a smart phone.

In another embodiment according to this aspect of the invention, the text message can include any one or more of a short message service (SMS) message, a multi-media messaging service (MMS) message, an instant message (IM), a facsimile, and an electronic mail (e-mail).

In a third aspect, the invention relates to a mobile computing device that includes a processor and a storage medium embedded with instructions. The instructions are executable by the processor for causing the processor to communicate a text message to a group of mobile computing devices via a communications server. The group of mobile computing devices is identified by a group name identifier and has an owner for managing the group. Each of the mobile computing devices of the group of mobile computing devices is able to join, leave, and communicate with the group of mobile computing devices without intervention by the owner of the group.

In one embodiment according to this aspect of the invention, the method can include attributing a credit to the owner of the group for each mobile computing device that joins the group of mobile computing devices in response to an invitation by the owner of the group. The method can also include creating a parent-child relationship between the owner of the group and the mobile computing device that joined the group of mobile computing devices in response to the invitation by the owner of the group. The method can also include attributing a credit to the owner of the group for each mobile computing devices that joins the group in response to an invitation by the child.

In another embodiment according to this aspect of the invention, the mobile computing device can include any one or more of a mobile phone, a mobile computer, a personal digital assistant, and a smart phone. The storage medium can include any one or more of random access memory (RAM), read-only memory (ROM), and flash memory.

In another embodiment according to this aspect of the invention, the text message can include any one or more of a short message service (SMS) message, a multi-media messaging service (MMS) message, an instant message (IM), a facsimile, and an electronic mail (e-mail). The text message can also include any one or more of a plurality of commands to communicate with the communication server.

In another embodiment according to this aspect of the invention, the communication server can be wirelessly connected to the mobile computing device and the group of mobile computing devices.

In a fourth aspect, the invention relates to a method of facilitating ad-hoc group formation. The methods includes receiving a text message from a mobile computing device, such as the mobile computing device described above, creating a text message on the mobile computing device, and transmitting the text message from the mobile computing device to the communication server.

In one embodiment according to this aspect of the invention, the method can include attributing a credit to the owner of the group for each mobile computing device that joins the group of mobile computing devices in response to an invitation by the owner of the group. The method can also include creating a parent-child relationship between the owner of the group and the mobile computing device that joined the group of mobile computing devices in response to the invitation by the owner of the group. The method can also include attributing a credit to the owner of the group for each mobile computing devices that joins the group in response to an invitation by the child.

In another embodiment according to this aspect of the invention, the mobile computing device can include any one or more of a mobile phone, a mobile computer, a personal digital assistant, and a smart phone. The storage medium can include any one or more of random access memory (RAM), read-only memory (ROM), and flash memory.

In another embodiment according to this aspect of the invention, the text message can include any one or more of a short message service (SMS) message, a multi-media messaging service (MMS) message, an instant message (IM), a facsimile, and an electronic mail (e-mail). The text message can also include any one or more of a plurality of commands to communicate with the communication server.

These and other objects, along with advantages and features of the invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same or similar parts throughout the different views. Also, the drawings are not necessarily to scale, emphasis instead generally being placed upon illustrating the principles of the invention.

FIG. 1 is a block diagram of a communication server configured to communicate a text message between a mobile computing device and a group of mobile computing devices.

FIG. 2 is a block diagram of an embodiment of a mobile computing device of FIG. 1.

FIG. 3 is a flow chart of a method of facilitating ad-hoc group formation via a communication server.

FIG. 4 is a flow chart of a method of facilitating ad-hoc group formation.

FIG. 5 is a flow chart of another method of facilitating ad-hoc group formation.

FIG. 6 is a flow chart of a method of automatically associating and tracking the hierarchy of a multi-level marketing structure and down-line of individual sales representatives.

### DESCRIPTION

In general, the invention relates systems and methods for ad-hoc and dynamic group formation among users of mobile computing devices without intervention by an owner of the group.

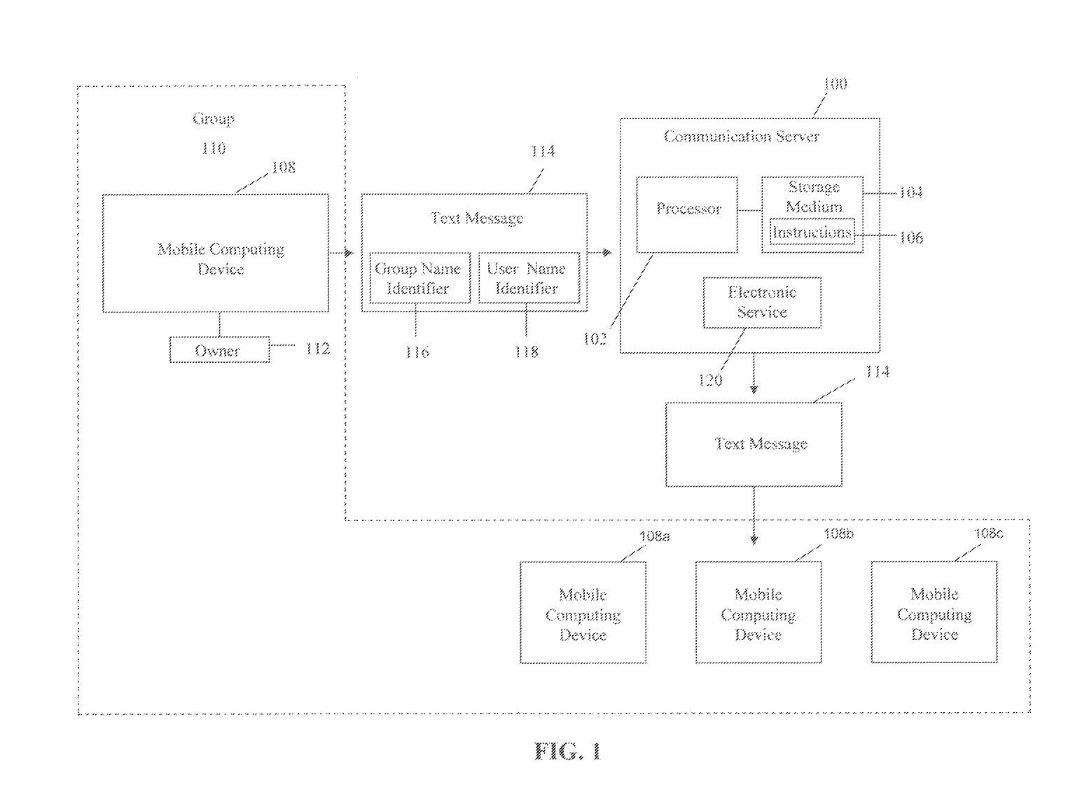

Referring to FIG. 1, in one embodiment according to the invention, a communication server 100 includes a processor 102 and a storage medium 104 embedded with instructions 106. The storage medium 104 can be any one or more of random access memory (RAM), read-only memory (ROM), and flash memory.

The communication server 100 is connected to a mobile computing device 108 and a group of mobile computing devices 110 via a wired or wireless connection. In this configuration, one or more mobile computing devices can be included in the group of mobile computing devices 110. For example, the user of the mobile computing device 108 may wish to communicate with other users of mobile computing devices. In order to achieve this communication, the user of the mobile computing device 108 may transmit a message to each of the users of mobile computing devices 108a, 108b, and 108c to have a group conversation. The user of the mobile computing device 108 and the users of other mobile computing devices 108a, 108b, and 108c are considered a group of mobile computing devices 110. The group of mobile computing devices 110 has an owner 112 for managing the functionality of the group 112. The owner 112 can be the user of mobile computing device 108.

Each of the mobile computing device 108, mobile computing device 108a, mobile computing device 108b, and mobile computing device 108c can be any one or more of a mobile phone, a mobile computer, a personal digital assistant, and a smart phone. Each of the mobile computing device 108, mobile computing device 108a, mobile computing device 108b, and mobile computing device 108c can be capable of receiving and transmitting audio, video, multi-media, voice or data over the Internet or a wireless network. In this manner, the mobile computing device 108, mobile computing device 108a, mobile computing device 108b, and mobile computing device 108c, collectively as the group of mobile computing devices 110, are capable of two-way communication by transmitting and receiving text messages between each other via the communication server 100.

The text message 114 can be provided in various formats, such as a text based communication in an electronic format. Other formats include, but are not limited to, audio, video, and multi-media based communication. For example, the text message 114 can be an electronic mail (e-mail), facsimile, instant messaging (IM), Multi-Media Messaging Service (MMS), Short Message Service (SMS), or an audio/video conference call.

The text message 114 includes a group name identifier 116. The group name identifier 116 is used to uniquely identify the group of mobile computing devices 110. A user name identifier 118 can also be embedded in the text message 114. The user name identifier 118 is associated with each of the mobile computing devices of the group of mobile computing devices 110. For example, the user name identifier 118 can be a telephone number of the mobile computing device 108. In this configuration, the text message 114 is comprised of the group name identifier 116, the user name identifier 118, such as the mobile computing device's telephone number, and any additional alphanumeric characters or symbols. In one embodiment, the user name identifier 118 does not include the mobile computing device's telephone number but rather includes alphanumeric characters, such as “John123”. In another embodiment, the telephone number is provided in the text message 114; however, the telephone number is not visible to the group of mobile computing devices 110.

In order to facilitate communication between the communication server 100 and the mobile computing devices, the instructions 106 embedded in the storage medium 104 are executable by the processor 102 such that the processor 102 communicates the text message 114 between the mobile computing device 108 and the group of mobile computing devices 110. The executable instructions 106 also causes the processor 102 to analyze the text message 114 transmitted from the mobile computing device 108. The executable instructions 106 also causes the processor 102 to broadcast the text message 114 to the group of mobile computing devices 110 based upon the group name identifier 116 without intervention by the owner 112 of the group of mobile computing devices 110.

The communication server 100 can also include an electronic service 120. Examples of the electronic service 120 may be, but are not limited to, Internet-based software (Software as a Service—SaaS), social networks, and mobile device based services (i.e., voice, data or messaging services). The electronic service 120 may be free to end-users with advertising-based revenue models or may be subscription-based, thereby requiring end-users to pay a period usage fee for the electronic service 120.

The electronic service 120 can be configured to attribute a credit to the owner 112 of the group of mobile computing devices 110 for each mobile computing devices that joins the group of mobile computing devices 110 in response to an invitation by the owner 112 of the group 110. The electronic service 120 can also create a parent-child relationship between the owner 112 of the group 110 and mobile computing devices that join the group of mobile computing devices 110 in response to the invitation by the owner 112 of the group 110. The owner 112 of the group 110 can also receive a credit for each mobile computing device that joins the group 110 in response to an invitation by the child.

For example, the electronic service 120 can automatically assign credit for sales and/or recruitment of new mobile computing devices to the group 110 based upon the explicit actions (Assignment Actions) of the user of the mobile computing device 108. For example, a user of the mobile computing device 108 may form a group 110 (become a representative) and receive credit for recruiting other users of mobile computing devices to the group 110. Upon creating the group, the user of mobile computing device 108 may invite new users of other mobile computing devices to join the group. As each new user receives an invitation to join the group 110, the communication server determines whether the new user is a member of the electronic service 120. If the user is a member of the electronic service 120, the communication server automatically creates a parent-child relationship between the inviting party and the new user once the new user joins the group 110. This relationship represents a down-line of a multi-level marketing network.

The use of an Assignment Action in a multi-level marketing network may be applicable in other applications. For example, in Web-based social networks, social networks grow predominantly through word of mouth and users sending electronic invitations to link to others, regardless of whether the invitee is already a user or not. If the invitation is accepted, the two subscribers are linked and may more easily correspond electronically and share information. If the invitee is not previously a user, he must become a user (i.e., agree to the terms and conditions and establish an account) in order to accept the invitation. An example of an Assignment Action in a social network may be the first link established by a new user, wherein the more tenured user that created the group receives credit for recruiting the new users.

Additionally, in a mobile device service, a mobile device is a long-range, electronic device used for mobile voice or data communication over a network of specialized base stations known as cell sites. In addition to the standard voice function of a mobile device, mobile devices may support many additional services and accessories, such as SMS for text messaging, e-mail, packet switching for access to the Internet, gaming, Bluetooth, infrared, camera with video recorder, MMS for sending and receiving photos and video, MP3 player, radio and GPS. An example of an Assignment Action with a mobile device service may be tracking the first person based upon the transmission of a phone call, SMS, or MMS.

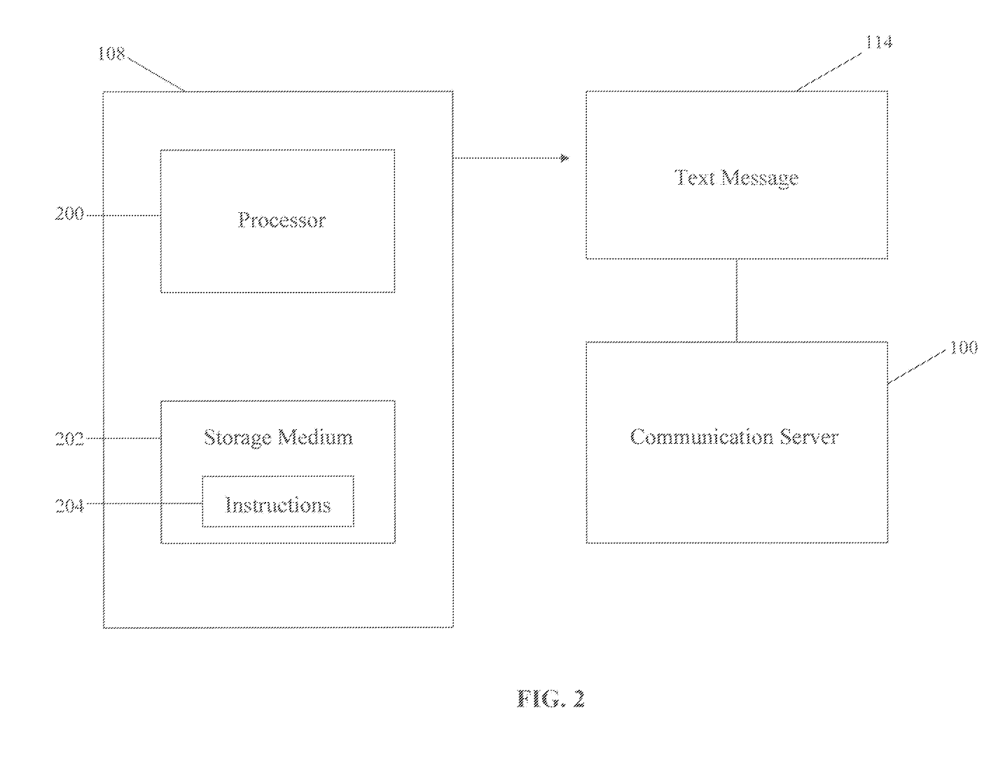

Referring to FIG. 1 and FIG. 2, in one embodiment, according to the invention, the mobile computing device 108 includes a processor 200 and a storage medium 202 embedded with instructions 204. The storage medium 202 can be any one or more of random access memory (RAM), read-only memory (ROM), and flash memory.

In order to facilitate communication between the mobile computing device 108 and the group of mobile computing devices 110, the instructions 204 embedded in the storage medium 202 are executable by the processor 200 such that the processor 200 communicates the text message 114 between the mobile computing device 108 and the group of mobile computing devices 110 via the communications server 100.

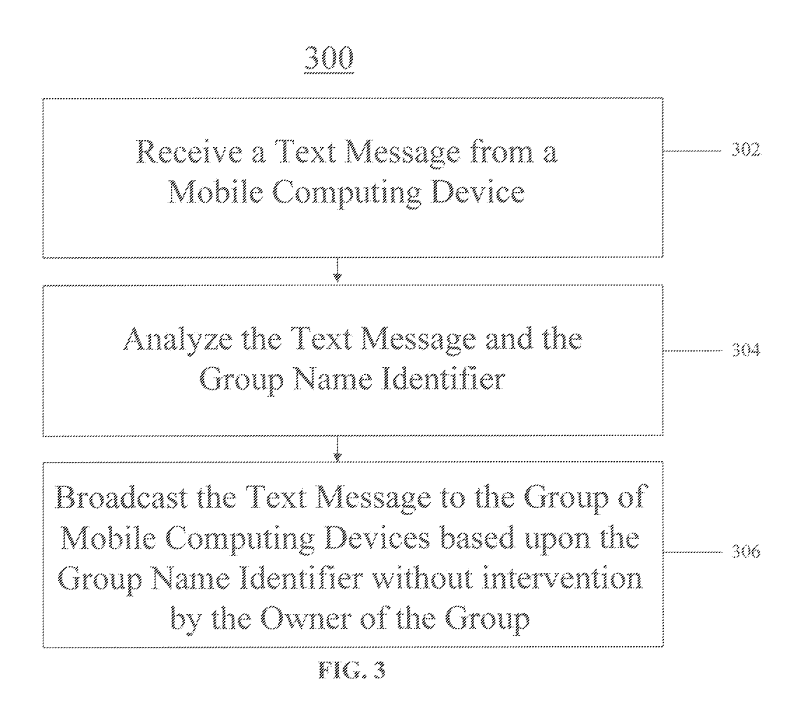

Referring to FIG. 3, in one embodiment according to the invention, a method of facilitating ad-hoc group formation via a communication server 300 includes the following steps: receiving a text message from a mobile computing device 302; analyzing the text message and the group name identifier 304; and broadcasting the text message to the group of mobile computing devices based upon the group name identifier without intervention by the owner of the group 306. For example, a communication server receives a text message from a mobile computing device at step 302. The server, upon receipt of the text message, analyzes the text message and the group name identifier to determine the appropriate response to the received text message. Upon identifying the appropriate group name identifier, the communication server broadcasts the message to the intended group of mobile computing devices without any intervention by the owner of the group at step 304.

If the communication server receives a text message with a request to register with a group messaging service hosted on the communication server, the communication server broadcasts a text message to the mobile computing device with instructions for joining the group messaging service. The text message may include the “Terms and Conditions” of the group messaging service. The text message that is sent by the communication server may also include instructions for creating a user name identifier for use with the service. The user may affirmatively respond to the message to join the group messaging service and the communication server will facilitate the creation of a user name. The user name identifier may be, for example, the mobile computing device's telephone number or a combination of alphanumeric characters or symbols.

If the message received by the communication server is a request to create a new group with a specific group name, the communication server can query an associated database to determine whether the requested group name is unique (i.e., currently used or reserved in the group messaging service). If the group name is not unique, the communication server can transmit a message requesting the user to select a new group name. Alternatively, if the group name is unique, the communication server reserves the group name, associates the user as the owner of the group, and sends the user a text message indicating that the group name is reserved. At or about the time an activity is supposed to commence, the communication server may receive text messages from users of other mobile computing devices that wish to join the group. The communication server can associate new members with the group and broadcast a text message to notify the owner of the newly joined members.

Once the group is established with at least one member and the owner, the communication server will broadcast messages to the members of the group. Although the owner is responsible for initially creating the group, the communication server does not require the owner to be responsible for managing or maintaining the group. Rather, members other than the owner are able elect to join, leave, or communicate with the group without any intervention or control by the owner. For example, the communication server can adjust the size of the group without instructions or involvement by the owner of the group. The owner is not explicitly involved or responsible for adding or removing group members. However, the owner can retain the ability to remove or block unwanted members and the sole ability to dissolve and/or disband a group.

The communication server can also accept additional types of messages. For example, if the text message is a request to discontinue the user's account with the group messaging service, the communication server will close the user's account upon receiving re-confirmation from the user. In the event the owner wishes to discontinue his account, the communication server shall close the owner's account as well as delete all groups associated with the owner. Other message types may include the following requests: (i) block or unblock all messages sent by a specific user; (ii) remove a specific user from a group; (iii) disassociate all users from a particular group; (iv) disassociate all users from a particular group and lock the group until the owner reactivates the group; (v) delete a group in its entirety; (vi) send a private message to a specific user in a group; (vii) set or change the default message that all new group members will automatically receive upon joining a group; (viii) change the focus of a group; (ix) change the owner's focus of a group; (x) request an invitation to join a group; (xi) invite one or more people to join a group; and (xii) associate the focus of a group to a specific group name.

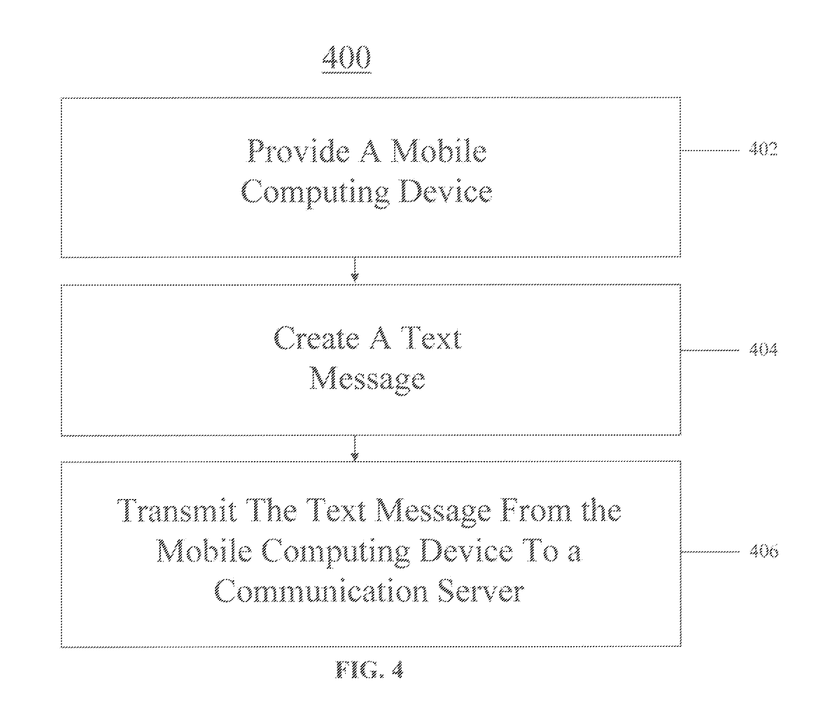

Referring to FIG. 4, in one embodiment according to the invention, a method of facilitating ad-hoc group communication 400 includes the following steps: providing a mobile computing device 402, such as the mobile computing device 108 of FIG. 1; creating a text message on the mobile computing device 404; and transmitting the text message from the mobile computing device to a communication server 406.

The user of the mobile computing device 108 can create a text message, at step 402. For example, the user may intend to form an ad-hoc or dynamic group based upon an interest or activity. Examples of activities that may benefit from ad-hoc and/or dynamic groups are families going to the mall for shopping, colleagues planning to meet during a trade show, college students on a spring break trip, or tourists with a tour guide on an organized trip. The user of the mobile computing device 108 can communicate a group name to the potential members of the group by word of mouth, phone calls, e-mail, SMS or any other messaging means. The user may then transmit a text message from the mobile computing device 108 to a communication server, such as communication server 100 of FIG. 1. Once a user of another mobile computing device is aware of the group name, that user may participate in the group by transmitting text messages without any intervention by the owner of the group. The ability to participate in a group in this manner provides dynamic ad-hoc group formation among users of mobile devices.

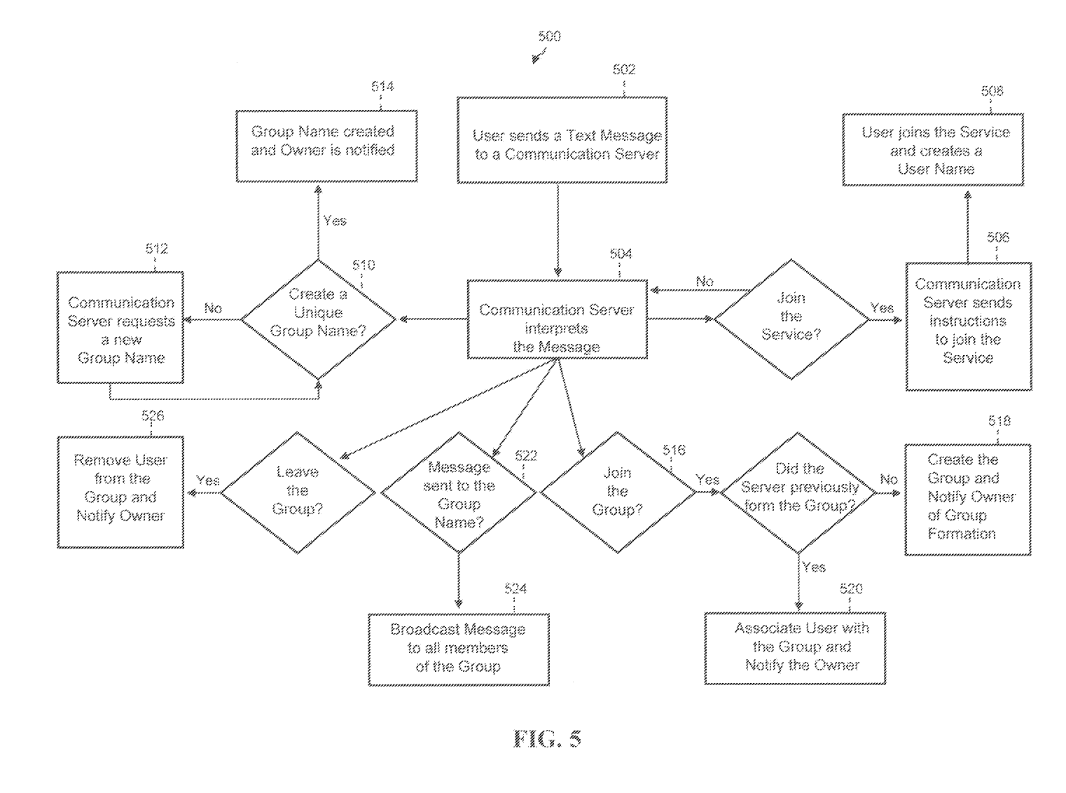

Referring to FIG. 5, in one embodiment according to the invention, another method of facilitating ad-hoc group communication 500 includes the following steps: sending a text message to a communication server from a mobile computing device 502; interpreting the text message to determine the type of request 504; sending a text message from the communication server to the mobile computing device with instructions to join the group messaging service 506; sending a text message to the communication server from the mobile computing device with an affirmative response to join the service 508; sending a text message to the communication server to create a new group 510; sending a text message from the communication server to the mobile computing device if the group name is not unique 512; sending a text message to the communication server from the mobile computing device with a unique group name 514; sending a text message to the communication server from another mobile computing device with instructions to join the group and notifying the owner of the group 516; creating the group if the group is non-existent 518; associating the mobile computing device with the group 520; determining if the text message is to be directed to a particular group of mobile computing devices 522; broadcasting text messages from the communication server to the group of mobile computing devices 524; and sending a text message to the communication server from a mobile computing device with instructions to leave the group without intervention by the owner of the group 526.

For example, a user of a mobile computing device transmits a message from his mobile device to a communication server that is connected to a networked environment at step 502. The communication server, upon receipt of the message, interprets the text of the message to determine the appropriate response to the user's request at step 504.

If the text message is a request to register with the group messaging service, the communication server sends the user a text message with instructions for joining the service and creating a user name at step 506. For example, the text message requesting to register with the group messaging service may be “#S.” The text message that is sent by the communication server may also include the “Terms and Conditions” of the group messaging service. The user may affirmatively respond to the text message to join the service and create a user name at step 508. The text message requesting to create or change a user name may be “#N{NAME}.” In one embodiment, if a user does not create a user name, his phone number will be displayed in any transmitted messages.

If the text message sent by the user to the communication server is a request to create a new group with a specific group name, such as the group name identifier 116 of FIG. 1, the processor executes instructions to query an associated database to determine whether the requested group name is unique (i.e., currently used or reserved in the group messaging service) at step 510. If the group name is not unique, the communication server transmits a text message requesting the user to select a new group name at step 512. If the group name is unique, the communication server reserves the group name, associates the user as the owner of the group, and sends the user a text message indicating that the group name is reserved at step 514. The text message requesting to create a new group may be “#G{Group Name}.” In one embodiment, the user's telephone number is also embedded in the text message. In this manner, the user does not need to explicitly identify himself to the communication server because the communication server is able to identify the phone number as a valid user of the group messaging service.

At or about the time the activity is supposed to commence, potential members of a group can elect to join the group by sending a text message from their mobile computing device, such as mobile computing device 108a, 108b, and 108c of FIG. 1, to the communication server that includes the group name at step 516. The text message requesting to join a group may be “#J{Group Name}.” In the case of a newly created group name, the communication server creates a group consisting of the owner and the first member(s) to join the group as well as transmits a message to the owner indicating that the group is formed at step 518. The communication server can associate a new member with a group and notify the owner of the newly joined member at step 520.

Once the group is established with at least one member and the owner, any member or the owner can direct messages to the group by utilizing the group name at step 522. The communication server can subsequently broadcast messages to the members of the group at step 524.

Although the owner is responsible for initially creating the group, the communication server does not require the owner to be responsible for managing or maintaining the group. Rather, individuals other than the owner are able elect to join or leave the group at their leisure. For example, the size of the group may change if members choose to leave the group by sending a message to the communication server at step 526.

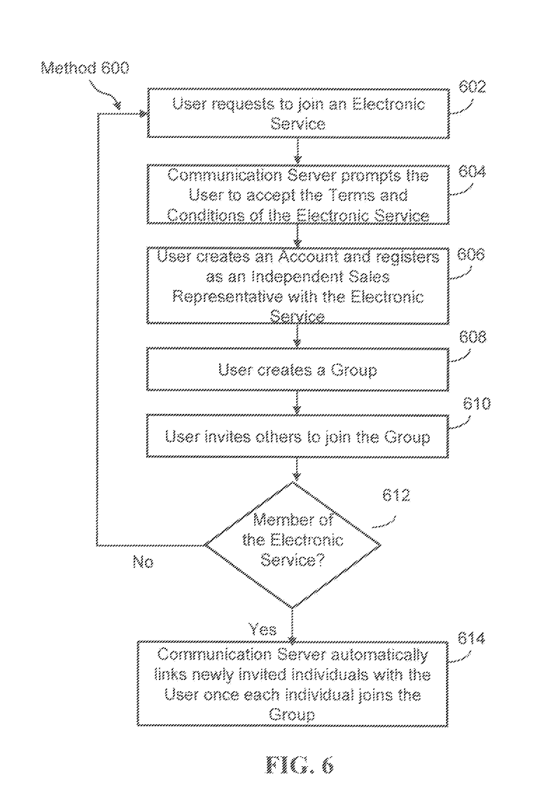

Referring to FIG. 6, in one embodiment according to the invention, a method of automatically associating and tracking the hierarchy of a multi-level marketing structure and down-line of individual sales representatives via an electronic service, such as electronic service 120 of FIG. 1, 600 includes the following steps: sending a text message to a communication server, such as the communication server 100 of FIG. 1, from a mobile computing device with a request to join an electronic service, such as the electronic service 120 of FIG. 1, 602; sending a text message from the communication server to the mobile computing device with instructions to accept the Terms and Conditions of the electronic service 604; creating an account and registering as an independent sales representative with the electronic service 606; sending a text message to the communication server from the mobile computing device with a request to create a group 608; sending a text message to other mobile computing devices with an invitation to join the group and associating the inviting mobile computing device as the owner of the group 610; receiving text messages from mobile computing devices with instructions to join the group and analyzing whether the mobile computing devices are registered with the electronic service 612; and automatically linking the newly invited mobile computing devices with the owner of the group 614.

For example, a user sends a text message to the communication server with a request to join an electronic service at step 602. The communication server, upon receipt of the request, sends a text message to the user to accept the “Terms and Conditions” of the electronic service at step 604. Upon sending a text message to the communication server with an affirmative acceptance of the Terms and Conditions, the user can create an account as well as register as an independent sales representative with the electronic service at step 606. A user can send a text message to the communication server to create a group at step 608. Upon creating the group, the user may invite new users to join the group at step 610. As each new user receives an invitation to join the group, the communication server determines whether the new user is a member of the electronic service at step 612. If the new user is not a member of the electronic service, the new user will proceed to step 602. If the user is a member of the electronic service, the communication server automatically creates a parent-child relationship between the inviting party and the new user once the new user joins the group at step 614. Additionally, upon each recipient registering with the electronic service and joining the group, the communication server automatically assigns credit to the owner of the group for recruiting the specific user. It is contemplated that an electronic service may utilize a group messaging service to track the growth of individual sales representatives. This process of automatically assigning credit for sales and/or recruitment of new representatives based upon an explicit actions of the new representatives represents the down-line of the multi-level marketing network.

It will be understood that various modifications may be made to the embodiments disclosed herein. Therefore, the above description should not be construed as limiting, but merely as illustrative of some embodiments according to the invention.

What is claimed is:

1. A communication server comprising:
a processor; and
a storage medium embedded with instructions, the instructions being executable by the processor for:
causing the processor to communicate a text message between a mobile computing device and a group of mobile computing devices;
causing the processor to analyze the text message transmitted from the mobile computing device; and
causing the processor to broadcast the message to the group of mobile computing devices based upon a group name identifier without intervention by the owner of the group, the group of mobile computing devices having an owner for managing the group, the group name identifier identifying the group of mobile computing devices.

2. The communication server of claim 1 further comprising an electronic service configured for attributing a credit to the owner of the group for each mobile computing device that joins the group of mobile computing devices in response to an invitation by the owner of the group.

3. The communication server of claim 2 wherein the electronic service creates a parent-child relationship between the owner of the group and the mobile computing device that joined the group of mobile computing devices in response to the invitation by the owner of the group.

4. The communication server of claim 3 wherein the owner of the group receives a credit for each mobile computing devices that joins the group in response to an invitation by the child.

5. The communication server of claim 1 wherein the mobile computing device includes any one or more of a mobile phone, a mobile computer, a personal digital assistant, and a smart phone.

6. The communication server of claim 1 wherein the storage medium includes any one or more of random access memory (RAM), read-only memory (ROM), and flash memory.

7. The communication server of claim 1 wherein the text message includes any one or more of a short message service (SMS) message, a multi-media messaging service (MMS) message, an instant message (IM), a facsimile, and an electronic mail (e-mail).

8. The communication server of claim 1 wherein the text message includes any one or more of a plurality of commands to communicate with the communication server.

9. The communication server of claim 1 wherein the text message includes a user name identifier that is associated with each of the mobile computing devices of the group of mobile computing devices.

10. The communication server of claim 9 wherein the user name identifier includes a phone number.

11. The communication server of claim 10 wherein the phone number is not visible to the group of mobile computing devices.

12. The communication server of claim 1 wherein the communication server is wirelessly connected to the mobile computing device and the group of mobile computing devices.

13. A method of facilitating ad-hoc group formation via a communication server comprising:
receiving a text message from a mobile computing device, the text message including a group name identifier associated with a group of mobile computing devices, the group of mobile computing devices having an owner for managing the group;
analyzing the text message and the group name identifier; and
broadcasting the text message to the group of mobile computing devices based upon the group name identifier without intervention by the owner of the group.

14. The method of claim 13 further comprising attributing a credit to the owner of the group for each mobile computing device that joins the group of mobile computing devices in response to an invitation by the owner of the group.

15. The method of claim 14 further comprising creating a parent-child relationship between the owner of the group and the mobile computing device that joined the group of mobile computing devices in response to the invitation by the owner of the group.

16. The method of claim 14 further comprising attributing a credit to the owner of the group for each mobile computing devices that joins the group in response to an invitation by the child.

17. The method of claim 13 wherein the mobile computing device includes any one or more of a mobile phone, a mobile computer, a personal digital assistant, and a smart phone.

18. The method of claim 13 wherein the text message includes any one or more of a short message service (SMS) message, a multi-media messaging service (MMS) message, an instant message (IM), a facsimile, and an electronic mail (e-mail).

19. A mobile computing device comprising:
a processor; and
a storage medium embedded with instructions, the instructions being executable by the processor for causing the processor to communicate a text message to a group of mobile computing devices via a communications server, the group of mobile computing devices being identified by a group name identifier and having an owner for managing the group, each of the mobile computing devices of the group of mobile computing devices being able to join, leave, and communicate with the group of mobile computing devices without intervention by the owner of the group.

20. The mobile computing device of claim 19 wherein the communication server includes an electronic service configured for attributing a credit to the owner of the group for each mobile computing device that joins the group of mobile computing devices in response to an invitation by the owner of the group.

21. The mobile computing device of claim 20 wherein the electronic service creates a parent-child relationship between the owner of the group and the mobile computing device that joined the group of mobile computing devices in response to the invitation by the owner of the group.

22. The mobile computing device of claim 20 wherein the owner of the group receives a credit for each mobile computing devices that joins the group in response to an invitation by the child.

23. The mobile computing device of claim 19 wherein the mobile computing device includes any one or more of a mobile phone, a mobile computer, a personal digital assistant, and a smart phone.

24. The mobile computing device of claim 19 wherein the storage medium includes any one or more of random access memory (RAM), read-only memory (ROM), and flash memory.

25. The mobile computing device of claim 19 wherein the text message includes any one or more of a short message service (SMS) message, a multi-media messaging service (MMS) message, an instant message (IM), a facsimile, and an electronic mail (e-mail).

26. The mobile computing device of claim 19 wherein the text message includes any one or more of a plurality of commands to communicate with the communication server.

27. A method of facilitating ad-hoc group formation comprising:
providing a mobile computing device, the mobile computing device including a processor and a storage medium embedded with instructions, the instructions being executable by the processor for causing the processor to communicate a text message to a group of mobile computing devices via a communications server, the group of mobile computing devices being identified by a group name identifier and having an owner for managing the group, each of the mobile computing devices of the group of mobile computing devices being able to join, leave, and communicate with the group of mobile computing devices without intervention by the owner of the group;
creating a text message on the mobile computing device; and
transmitting the text message from the mobile computing device to the communication server.

28. The method of claim 27 further comprising attributing a credit to the owner of the group for each mobile computing device that joins the group of mobile computing devices in response to an invitation by the owner of the group.

29. The method of claim 27 further comprising creating a parent-child relationship between the owner of the group and the mobile computing device that joined the group of mobile computing devices in response to the invitation by the owner of the group.

30. The method of claim 27 further comprising attributing a credit to the owner of the group for each mobile computing devices that joins the group in response to an invitation by the child.

31. The method of claim 27 wherein the mobile computing device includes any one or more of a mobile phone, a mobile computer, a personal digital assistant, and a smart phone.

32. The method of claim 27 wherein the storage medium includes any one or more of random access memory (RAM), read-only memory (ROM), and flash memory.

33. The method of claim 27 wherein the text message includes any one or more of a short message service (SMS) message, a multi-media messaging service (MMS) message, an instant message (IM), a facsimile, and an electronic mail (e-mail).
